(19) United States
(12) Patent Application Publication
(10) Pub. No.: US 2012/0050065 A1
(43) Pub. Date: Mar. 1, 2012

(54) SYSTEMS AND METHODS FOR NETWORK ENABLED DATA CAPTURE

(76) Inventor: Steven A. Lombardi, Whitewater, WI (US)

(21) Appl. No.: 12/871,248

(22) Filed: Aug. 30, 2010

(51) Int. Cl. G08C 19/00

(52) U.S. Cl. 340/870.02

(57) ABSTRACT

Networked meters in a distribution system are enabled to detect a trigger event, record its time-stamped local data, and to issue a capture command via the network. The capture command includes timing data of the trigger event so the networked meters receiving the command are able to go back into their time-stamped and recorded local data and extract a precisely time-coordinated capture of their local data associated with the timing data of the trigger event. A complete set of distribution system event data is captured that may be time-synchronized for analysis.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates generally to networked meters and, more particularly, to systems and methods including networked meters for detecting events and capturing system data relative to the events.

Often, in a facility power distribution system there may be several different busses connected via power transformers in a manner similar to that generally shown in the distribution system of FIG. 1. Unfavorable events, such as voltage sags, swells, or transient events can occur randomly at the input to the facility or at any location within the distribution system. These events can damage or reduce the life of equipment connected to the distribution system, they can cause connected equipment to malfunction, or even worse, cause harm to personnel. Results of such an event can include a reduction in product quantity and quality, and/or an unplanned shutdown of all or part of the facility. Therefore, it is desirable to detect these events when they occur, and capture distribution system data, such as voltage, current, and/or waveform data prior to, during, and after the event. The captured data can then be examined and analyzed in an effort to understand the event and determine the cause of the event. Potential corrective actions can be identified and implemented to reduce or eliminate a reoccurrence of the event.

FIG. 1 shows the general power distribution system employing stand alone electronic power monitor type meters placed on the secondary side of each distribution transformer. When an event occurs, one of two strategies is typically used to acquire the distribution system data needed for analysis of the event and to determine a possible cause.

One strategy that has been employed is to provide one or more meters that continuously records all of the metered data. When an event occurs, the analyzer (e.g., system user or facility personnel) of the recorded data can go back in time and sort through the large amounts of data to find any clues to the cause of the event. This strategy can be an effective way to troubleshoot the distribution system. However, it has the disadvantage that a lot of data is recorded that has no real value since it reflects the operation of a normally functioning system. The analysis process is complicated by having to sort through the meaningless data in order to get to the small window of time (e.g., may be milliseconds or less) when the event occurred. It also has the disadvantage that a significant amount of memory (or other data storage mechanism) is required whether or not an event occurred. This unnecessarily increases the cost, complexity, and size of the meter.

A second strategy that has been employed is to configure each of the meters in the distribution system with trigger parameters (e.g., a predetermined magnitude and/or duration of the event, and/or value of metered data), to allow each meter in the system to individually recognize an event and record the desired system information for a short period of time before, during, and after the event. The use of meters with trigger parameters significantly reduces or eliminates the issue of storing large amounts of nominal data which is of little value.

This second strategy has the disadvantage that not all of the configured meters in the distribution system are guaranteed to identify and record an event, including the same event, because the event characteristics may be significantly different at different locations in the distribution system. For example, if an event occurs near meter 28, that meter would likely trigger and record the data for the short period of time before, during, and after the event (assuming the meter was appropriately configured). However, the event would likely be far less significant at meter 20 and may be much attenuated at meter 23. In actuality, it is very likely that meter 23 may not sense the event at all and therefore not record any data, even though a secondary problem could have occurred on meter 23's local loads. In addition, the total distribution system data available to analyze the event will be compromised if only some of the meters record their local data. In an effort to compensate for this deficiency, the metering trigger points could be made more sensitive to try to ensure that all meters will record data, however this would likely result in many “nuisance triggers” that do not represent an actual problem. Once again unnecessary data would have been recorded. Although this second strategy may improve the cost and complexity of the meter, the aggregate quality of the collected system wide data may actually be compromised.

It would, therefore, be desirable to have systems and methods for capturing a complete image of distribution system data upon the occurrence of an event that use networked meters with configurable trigger parameters to capture time-stamped event data, and, are further capable of issuing a command via the network, with the command including the precise time of the event. The command instructs all or some of the remaining meters on the network to also capture their respective time-stamped local data associated with the precise time of the event so as to provide a complete time-synchronized image of the distribution system event data.

### BRIEF SUMMARY OF THE INVENTION

The present embodiments overcomes the aforementioned drawbacks of the previous strategies by providing systems and methods for enabling networked meters in a distribution system to detect one or more power system electrical parameters that are defined by the trigger parameters (referred to as a trigger event), record the precise time associated with the trigger event, timestamp and record its local data, and to also issue a command via the network, with the command including the precise time of the trigger event. The command instructs all or some of the remaining meters on the network to also capture their time-stamped local data. The command includes the precise timing of the trigger event so the meters on the network receiving the command are able to go back into their time-stamped and recorded local data and extract a precisely time-coordinated capture of their local data. The captured data from all the meters provides a complete time synchronized set of distribution system event data for analysis. By providing the trigger event time stamp in the capture command, the time skew can be eliminated from the distribution system event data captured by the multiple meters in the system. The trigger enabled and networked meters significantly reduce or eliminate the need to store large amounts of nominal data, and are able to provide a time-synchronized complete or predetermined view of the distribution system event data for analysis.

In accordance with some aspects of an embodiment, a modular system and method includes multiple meters connected to a communication network, e.g., Ethernet, LAN, WAN, or wireless, as non-limiting examples. Each networked meter in the system is preconfigured with appropriate trigger parameters. When a meter on the network detects a trigger event, it records its time-stamped local data and also issues a command via the network to tell all or some of the remaining meters to also capture their respective time-stamped local data. The command includes the precise timing of the trigger event so the meters on the network receiving the command are able to go back into their time-stamped and recorded local data and extract a precisely time-coordinated capture of their local data.

This embodiment is able to create a complete time-synchronized image of all the metered distribution system data whenever an event occurs. It also significantly reduces the need for a user to make the trigger parameters overly sensitive because the meter closest to the cause of the event will most likely see a significant change and easily trigger. Since all of the other meters receiving the command over the network will respond to the command, they will have also captured their local data and are then able to extract a precisely time-coordinated capture of their local data associated with the trigger event without the need to configure overly sensitive trigger parameters. It is contemplated that only a subset of all the meters may be instructed via a network command to capture their local data.

This novel approach significantly reduces the amount of memory required for each meter since long term continuous recording does not take place. It is contemplated that the amount of metered data that may be recorded need only contain a predetermined amount of metered data sufficient to span a short time before, during, and after the event, e.g., the data is only temporarily recorded as it is time-stamped, buffered in, stored for a predetermined amount of time, and then deleted (e.g., overwritten). In addition, it significantly reduces the occurrence of nuisance recordings since trigger levels do not need to be overly sensitive. The systems and methods reduce both system cost and complexity while ensuring that a full and robust set of distribution system data is available to analyze the event.

In accordance with one aspect of the invention, a power quality measurement, control and management device for use in an electric power system is provided. The power quality measurement, control and management device comprises an electric power system metering assembly including data memory and trigger parameters, the metering assembly being adapted to capture, time stamp, and record in the data memory power system electrical parameters imposed on one or more industrial automation devices, with each industrial automation device representing a node in the electric power system, the recorded power system electrical parameters being stored in the data memory for a predetermined amount of time. A communication interface may be coupled to the metering assembly, the communication interface being adapted to communicate with one or more additional metering assemblies on a network, and the communication interface adapted to transmit a capture command to all or a subset of the one or more additional metering assemblies on the network. In operation, when the metering assembly captures one or more power system electrical parameters that are defined by the trigger parameters, the communication interface transmits the capture command onto the network to instruct all or the subset of the one or more additional metering devices on the network to record their respective power system electrical parameters.

In some aspects of the invention, when the metering assembly captures one or more power system electrical parameters that are defined by the trigger parameters, the metering assembly takes a snapshot of the recorded power system electrical parameters and stores the snapshot of the recorded power system electrical parameters in the data memory.

In other aspects of the invention, the metering assembly issues the capture command and forwards the capture command to the communication interface to be transmitted onto the network.

In other aspects of the invention, the communication interface is coupled to a processor assembly, and the processor assembly issues the capture command and forwards the capture command to the communication interface to be transmitted onto the network.

In other aspects of the invention, the communication assembly is electrically coupled to the metering assembly by way of a backplane assembly. The backplane assembly may be adapted to pass both system voltage and communication signals.

In other aspects of the invention, the trigger parameters are preconfigured, and they may be preconfigured across the network.

In other aspects of the invention, the capture command includes timing data of the electrical parameters that are defined by the trigger parameters. The capture command may instruct all or the subset of the one or more additional metering devices on the network to record their respective power system electrical parameters associated with the timing data of the electrical parameters that are defined by the trigger parameters.

In other aspects of the invention, a power supply may be included, the power supply adapted to accept user input voltage, and to configure the input voltage to a system voltage for use by the metering assembly. The backplane assembly may be adapted to pass at least one of system voltage and communication signals. The system voltage may be transmitted from the power supply, across the backplane, and to the metering assembly.

In accordance with another aspect of the invention, a power quality measurement, control and management device for use in an electric power system and adapted to be coupled to a network is provided. The power quality measurement, control and management device comprises an electric power system metering assembly including data memory and trigger parameters, the metering assembly being adapted to capture, time stamp, and record in the data memory power system electrical parameters imposed on one or more industrial automation devices, each device representing a node in the electric power system. A processor assembly including a communication interface may be included, the communication interface being adapted to communicate with one or more additional metering assemblies on a network, and the communication interface adapted to transmit a capture command to all or a subset of the one or more additional metering assemblies on the network. Each of the metering assembly and the processor assembly may be coupled to a backplane assembly, the backplane assembly adapted to pass communications between the metering assembly and the processor assembly. When the metering assembly captures one or more power system electrical parameters that are defined by the trigger parameters, the metering assembly takes a snapshot of the recorded power system electrical parameters and stores the snapshot of the recorded power system electrical parameters in the data memory.

In one aspects of the invention, a power supply may be coupled to the backplane assembly, the power supply adapted to accept user input voltage, and to configure the input voltage to a system voltage for use by the processor assembly and the metering assembly.

In other aspects of the invention, the snapshot of the recorded power system electrical parameters may be stored in the data memory separate from the recorded power system electrical parameters. The backplane may also be adapted to provide electrical isolation between the processor assembly and the metering assembly and the power supply.

In other aspects of the invention, when the metering assembly captures one or more power system electrical parameters that are defined by the trigger parameters, the communication interface transmits the capture command onto the network to instruct all or the subset of the one or more additional metering devices on the network to take a snapshot of the one or more additional metering device's recorded power system electrical parameters and to store the one or more additional metering device's snapshot of the recorded power system electrical parameters in the one or more additional metering device's data memory.

In other aspects of the invention, the capture command includes timing data of the electrical parameters that are defined by the trigger parameters. The capture command may also instruct all or the subset of the one or more additional metering devices on the network to record their respective power system electrical parameters associated with the timing data of the electrical parameters that are defined by the trigger parameters.

In accordance with yet another aspect of the invention, a method of capturing power system electrical parameters with a plurality of networked electric power system metering assemblies is provided. The power system electrical parameters are imposed on one or more industrial automation devices, each device representing a node in the electric power system. The method comprises the steps of capturing, time stamping, and recording the power system electrical parameters imposed on the one or more industrial automation devices by at least one of the plurality of networked electric power system metering assemblies, comparing the power system electrical parameters to trigger parameters; and when the power system electrical parameters fall within the trigger parameters, instructing all or a subset of the plurality of networked electric power system metering assemblies on the network to take a snapshot of the respective metering device's recorded power system electrical parameters.

In one aspects of the invention, the instructing step further includes instructing all or a subset of the plurality of networked electric power system metering assemblies on the network to take a snapshot of the respective metering device's recorded power system electrical parameters associated with timing data of the electrical parameters that fall within the trigger parameters.

In other aspects of the invention, another step may include time-synchronizing a plurality of the snapshots of the respective metering device's recorded power system electrical parameters, and may further include presenting the time-synchronized snapshots to a user for analysis.

To the accomplishment of the foregoing and related ends, the embodiments, then, comprise the features hereinafter fully described. The following description and the annexed drawings set forth in detail certain illustrative aspects of the invention. However, these aspects are indicative of but a few of the various ways in which the principles of the invention can be employed. Other aspects, advantages and novel features of the invention will become apparent from the following detailed description of the invention when considered in conjunction with the drawings.

### BRIEF DESCRIPTION OF THE SEVERAL VIEWS OF THE DRAWINGS

The embodiments will hereafter be described with reference to the accompanying drawings, wherein like reference numerals denote like elements, and:

FIG. 1 is a schematic diagram of a power distribution system and associated stand alone power monitor type meters;

FIG. 2 is a schematic diagram of a power distribution system, with networked meters in accordance with the present embodiments;

FIG. 3 is a block diagram of one embodiment of a networked meter in accordance with the present embodiments;

FIGS. 4 and 5 are block diagrams of embodiments of memory regions;

FIG. 6 is a schematic diagram of a simplified embodiment of the power distribution system of FIG. 2, and including additional devices on the network;

FIG. 7 is a flow chart showing exemplary steps that may be carried out in accordance with the present embodiments; and

FIG. 8 is a block diagram of time synchronized distribution system event data.

### DETAILED DESCRIPTION OF THE INVENTION

The various aspects of the invention will be described in connection with various systems and methods for metering electrical distribution systems and capturing a complete (or predetermined) image of the metered electrical distribution system data for analysis. That is because the features and advantages that arise due to the invention are well suited to this purpose. For this reason, the systems and methods will be described in the context of modular meters adapted to meter electrical distribution systems. Still, it should be appreciated that the various aspects of the invention can be applied to achieve other objectives as well. For example, the systems and methods of the present invention may include meters adapted to meter other types of distribution systems, such as water, gas, steam, and air, as non-limiting examples, for the same or similar purposes.

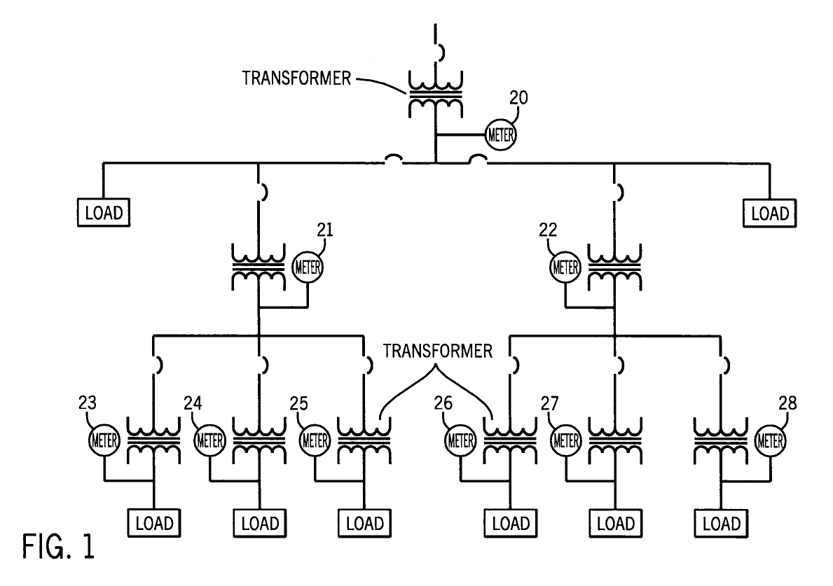

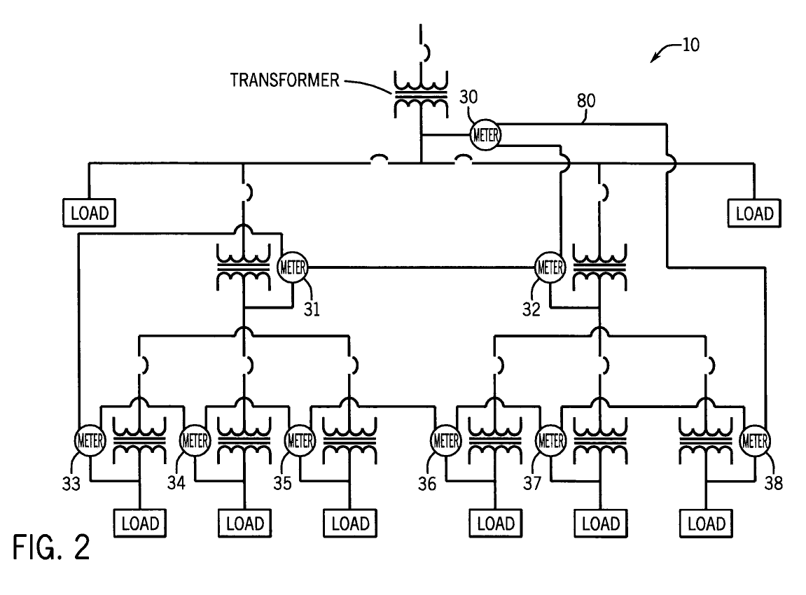

Referring now to FIG. 2, to overcome the drawbacks addressed above, the system of FIG. 1 is replaced with a system 10 including multiple networked meters 30 through 38. As can be seen, the multiple meters are located in predetermined locations, e.g., placed on the secondary side of each distribution transformer in the system and ahead of one or more loads, as a non-limiting example. When one (or more) of the meters in the system detects a trigger event, it not only records its time-stamped local data, but it may also issue a command via the network that includes the precise timing of the trigger event so the other meters on the network receiving the command are instructed to go back into their time-stamped and recorded local data and extract a precisely time-coordinated capture of their local data associated with the precise time of the trigger event.

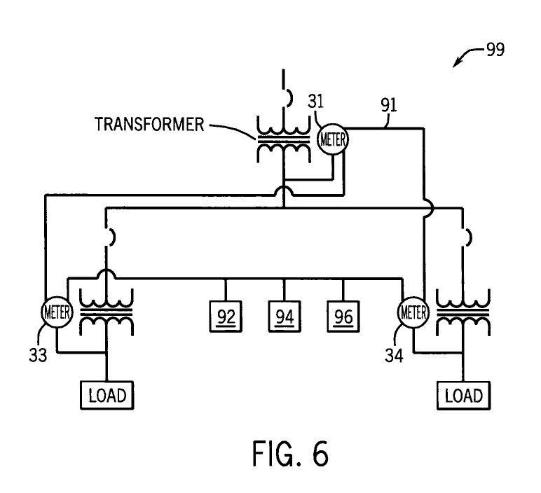

In order to better understand the systems and methods described herein, first, an exemplary networked meter 31 will be described, and then the use and operation of the meter 31 in the system 99 of FIG. 6, and the meter's interaction with the remaining meters in the system 99 will be described.

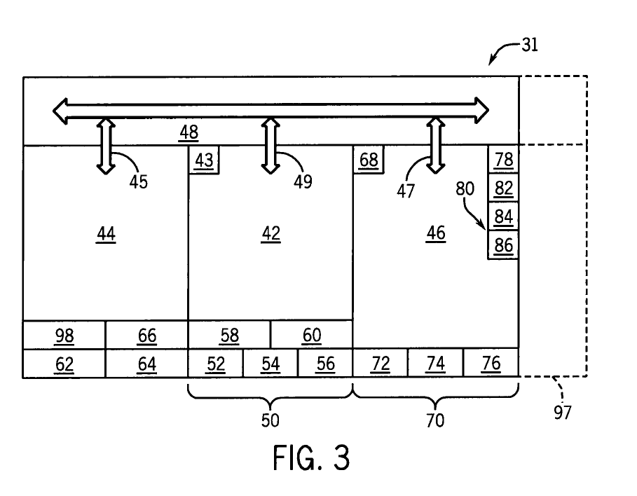

Referring to FIG. 3, exemplary meter 31 includes a processor assembly 42, a power supply assembly 44, a local data metering assembly 46, and a backplane assembly 48. Each assembly will now described in further detail. It is to be appreciated that the meter 31 may comprise modular components and may include alternative configurations as well. For example, one or more of the assemblies may be combined, and/or features described for one assembly may be located on a different assembly. Processors, memory, and communications may be located in or on one or more of the assemblies, and/or elsewhere on the network. Additionally, optional modular assemblies 97 providing additional system or metering related functions may also be included.

Processor assembly 34 may include one or more processors 43, and may be configured to be responsible for top level control of the meter 31. The processor assembly may also be configured to manage its communications 49 to and from the backplane assembly 48. Processor assembly 42 may also include a communications interface 50 including one or more user accessible communication ports 52, 54, 56 (three are shown, although more or less are contemplated). For example, the communication ports may be configured for a variety of communication protocols, including but not limited to USB, serial, wireless, Bluetooth, EtherNet, DeviceNet, ControlNet, and Ethernet with Device Level Ring (DLR) technology. The DLR technology also supports the IEEE 1588 standard for precise time synchronization and standardized Quality of Service (QoS) mechanisms to help prioritize data transmission. One or more of the communication ports allows the meter 31 to be networked to additional meters. Processor assembly 42 may also include signal level inputs 58 and outputs 60 for access by the user.

The power supply assembly 36 accepts user input voltage in either VAC and/or VDC at VAC input 62 and VDC input 64, and configures the input voltage to a system or output voltage that may then be supplied to the backplane assembly 48 for distribution to assemblies e.g., processor assembly 42 and local data metering assembly 46, coupled to the backplane. The power supply assembly may be configured to manage its communications 45 to and from the backplane assembly 48. It is to be appreciated that both input and output voltages may range from low voltage levels to high voltage levels as is well known in the art. It is also to be appreciated that transformers known in the art may also be used with high voltage systems. The power supply assembly may also be configured to include standby power, e.g., a standby capacitor or battery 66, for providing power to the meter 31 when user input voltage is temporarily not available.

The local data metering assembly 46 may include one or more processors 68, and may be configured as the computation engine for the metered local data and may also be configured to manage its communications 47 to and from the backplane assembly 48. The local data metering assembly 46 is shown to include an input interface 70 for the metered data. For example, the inputs may be configured for an analog input 72, a voltage input 74, and a current input 76. Contemplated electrical systems include all configurations of single, two, and three phase systems, as non-limiting examples. The input interface 60 allows for a direct connection to both standard and non-standard three-phase wiring topologies. As non-limiting examples, topologies that may be supported include 4 wire wye (both grounded or ungrounded neutral), 3 wire wye, delta/open delta, corner grounded delta, high leg delta, and impedance grounded wye.

The backplane assembly 48 may be configured as a local Ethernet backplane, although other configurations are contemplated, such as a proprietary configuration. Each assembly coupled to the backplane assembly 48 is adapted to draw power, e.g., a system voltage, from the backplane assembly and communicate with other assemblies across the backplane assembly 48. In addition, the backplane assembly 48 may be configured to provide electrical isolation between assemblies coupled to the backplane assembly.

The system 10 may further incorporate a time protocol for correlation and/or time stamping the metered data. In one embodiment, the time protocol comprises the precision time protocol (PTP) defined in the IEEE 1588 standard. Other methods for time coordination are contemplated, including other protocols such as the network time protocol (NTP or Simple NTP), global positioning system (GPS), and a variety of other known or future developed time protocols. As a local Ethernet backplane, the backplane assembly 48 is able to support the IEEE 1588 precision time protocol. As the data is received at the local data metering assembly 46, it is time-stamped by the time protocol so it can be correlated in time with the time-stamped data from other meters.

The local data metering assembly 46 may further include system memory 78 and data memory 80. Optionally, the system memory 78 may be located in the processor assembly 42. The system memory may be included to store operational parameters, such as the trigger parameters 82. Trigger parameters 82 will be further described below. The data memory 80 may be included to store the metered data, and may be divided into two regions (although not required), a buffer region 84 for buffering the metered data as it is received, processed, stored for a predetermined amount of time, and then deleted, and a trigger data region 86 for recording the time-stamped local trigger event data.

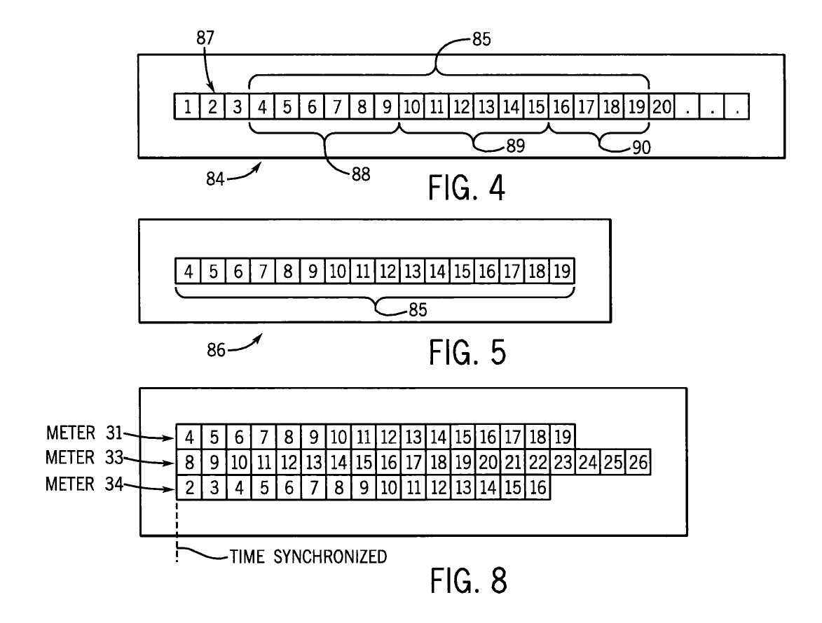

Referring to FIGS. 4 and 5, the recorded trigger event data may comprise a snapshot 85, such as a memory read of all or a portion of the buffered data 87 for a short period of time before, during, and after the trigger event. It is contemplated that the short period of time may be about 0.001 seconds, to about a second, to about a minute, to about a day, to about a week, or to about a month, or more or less. When a trigger event occurs, the processor 58 is adapted to take a snapshot 85 of the metered data 87 and copy the snapshot from the buffer region 84 to the trigger data region 86, the snapshot including the desired amount of time-stamped trigger event data before 88, during 89, and after 90 the trigger event. The amount of data memory 80 can vary, and it is to be appreciated that the system memory 78 and the data memory 80 may comprise the same or separate memory.

As seen in FIG. 6, the previously described communication interface 60 of each meter provides access to other meters on a network 91. Additional devices such as a laptop 92, a display 94, and/or a Human Machine Interface (HMI) 96, as non-limiting examples, may also reside on the network 91 and may communicate directly or indirectly with one or more of the meters or other devices on the network. The additional devices allow a user to access each meter for configuration and data analysis, as discussed below.

FIG. 6 is provided to simplify the description of the use and operation of the system 99 and meters 31, 33, and 34. System 99 is a representative scaled down version of the system 10 shown in FIG. 2. To configure the system 99 for operation, meters 31, 33, and 34 are placed in desired locations so as to be well suited to meter the desired characteristics of the system 99.

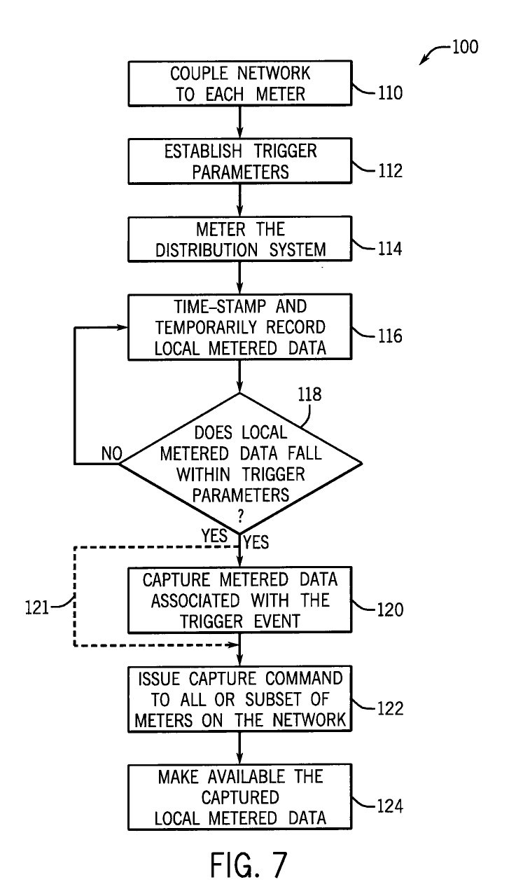

The steps performed while practicing an exemplary embodiment of the invention consistent with the embodiments described above are set forth in FIG. 7. Referring particularly to FIG. 7, the first step is to couple the network 91 to the communication interface 50 on each meter 31, 33, and 34 as indicated at process block 110. Although the network 91 is shown as a ring topology, it is to be appreciated that other topologies may also be used, such as a star, bus, tree, fully-connected, line, or wireless, as non-limiting examples. The network 91 is coupled to the communication interface 50 on each meter 31, 33, and 34, and is configured to allow communication between the meters and, if desired, to allow communication with other devices on the network as well, such as laptop 92, display 94, and HMI 96.

At process block 112, trigger parameters 82 may then be established for each meter 31, 33, and 34. It is contemplated that the trigger parameters 82 may be entered into a laptop 92 or HMI 96 on the network and downloaded to each meter via access across the network 91, or may be entered via a device coupled to a port on each meter's communication interface 50, or the meter may include user inputs 98 on the face of the meter (see FIG. 3, shown on the power supply assembly 44). The trigger parameters 82 are generally determined by the user and are based on the characteristics of the system. Trigger parameters 82 may be established for a wide variety of data forms and characteristics, including, but not limited to voltage, current, waveforms, magnitude, duration, location, etc.

Next, at process block 114, the distribution system is metered. In the process of metering the distribution system, each meter 31, 33, 34 receives its local metered data at the metered data input interface 70. At process block 116, the processor 68 in the local data metering assembly 46 of meter 31 time-stamps the local metered data and temporarily records the time-stamped local metered data in the data memory 80 or buffer region 84.

Next, at process block 118, the processor 68 compares the local metered data to the preconfigured trigger parameters 82. If the local metered data does not fall within the trigger parameters, no action is taken and the local metered data continues to be time-stamped and temporarily recorded, as indicated in process block 116.

When the processor 68 compares the local metered data to the preconfigured trigger parameters 82 and detects a trigger event, such as when the local metered data reaches a trigger point, e.g., falls within the trigger parameters or reaches a trigger maximum or minimum value, at process block 120, processor 68 captures the time-stamped local metered data associated with the trigger event. The data capture may include taking a snapshot 85 of the time-stamped local metered data 87 currently buffered in the buffer region 84, which is sized so as to include the predetermined amount of local metered data before 88, during 89, and after 90 the trigger event, and storing the snapshot local metered data in the trigger data region 86.

Next, in process block 122, or optionally, in parallel (shown in dashed lines 121) with process block 120, processor 68 issues a data capture command across the network 91. The command includes the precise timing of the trigger event so the meters on the network receiving the command are able to go back into their time-stamped and recorded local data and extract a precisely time-coordinated capture, i.e., taking a snapshot, of their time stamped local metered data associated with the trigger event and recording the snapshot local metered data in their respective trigger data region 86. In the illustrated embodiment of FIG. 6, meter 33 and meter 34 (or one or the other) receive the capture command with the precise timing of the trigger event and initiate a snapshot capture of their respective metered data associated with the precise timing of the trigger event. Including the timing data of the trigger event in the capture command reduces or eliminates any time skew in the distribution system event data due to the amount of time required to identify an event, send the command, and any network delays, for example.

Optionally, at process block 124, once the trigger event data has been captured, the trigger event data may be made available to the user for analysis. It is contemplated that the time-stamped trigger event data from each, or one or more of the meters 31, 33, and 34 may be made available to the laptop 92, display 94, or HMI 96, for example. One or more of the devices 92, 94, 96 may include software configured to analyze the data. The captured time-stamped trigger event data may then be correlated in time (see FIG. 8) to produce a complete picture of the distribution system at the time just before, during, and after the trigger event occurred. The captured time-stamped trigger event data may be correlated at the start of the snapshot, as shown, or may be correlated at the start of the trigger event data, or other correlations as desired by the user. The software may provide a wide variety of information to the user, such as an indication of the first trigger and any subsequent triggers, or a confidence level may be provided, based on the analyzed data, relative to the stability of the system 10.

Therefore, networked meters for detecting events and capturing system data relative to the events is provided. It is contemplated that the metered data from a distribution system may be time-stamped and temporarily recorded. If the metered data falls within preconfigured trigger parameters, the metered data associated with the trigger even is captured and a command is issued to all or a subset of the meters on the network to capture their time-stamped local metered data associated with the precise timing of the trigger event. The time-synchronized data may then be made available to the user for analysis as a complete view of the distribution system event data.

The present invention has been described in terms of the various embodiments, and it should be appreciated that many equivalents, alternatives, variations, and modifications, aside from those expressly stated, are possible and within the scope of the invention. Therefore, the invention should not be limited to a particular described embodiment.

I claim:

1. A power quality measurement, control and management device for use in an electric power system, the device comprising:
an electric power system metering assembly including data memory and trigger parameters, the metering assembly adapted to capture, time stamp, and record in the data memory power system electrical parameters imposed on one or more industrial automation devices, each industrial automation device representing a node in the electric power system, the recorded power system electrical parameters being stored in the data memory for a predetermined amount of time;
a communication interface coupled to the metering assembly, the communication interface adapted to communicate with one or more additional metering assemblies on a network, and the communication interface adapted to transmit a capture command to all or a subset of the one or more additional metering assemblies on the network; and
wherein when the metering assembly captures one or more power system electrical parameters that are defined by the trigger parameters, the communication interface transmits the capture command onto the network to instruct all or the subset of the one or more additional metering devices on the network to record their respective power system electrical parameters.

2. The device according to claim 1:
wherein when the metering assembly captures one or more power system electrical parameters that are defined by the trigger parameters, the metering assembly takes a snapshot of the recorded power system electrical parameters and stores the snapshot of the recorded power system electrical parameters in the data memory.

3. The device according to claim 1:
wherein the metering assembly issues the capture command and forwards the capture command to the communication interface to be transmitted onto the network.

4. The device according to claim 1:
wherein the communication interface is coupled to a processor assembly, and the processor assembly issues the capture command and forwards the capture command to the communication interface to be transmitted onto the network.

5. The device according to claim 4:
wherein the communication assembly is electrically coupled to the metering assembly by way of a backplane assembly.

6. The device according to claim 5:
wherein the backplane assembly is adapted to pass both system voltage and communication signals.

7. The device according to claim 1:
wherein the trigger parameters are preconfigured.

8. The device according to claim 1:
wherein the trigger parameters are preconfigured across the network.

9. The device according to claim 1:
wherein the capture command includes timing data of the electrical parameters that are defined by the trigger parameters.

10. The device according to claim 9:
wherein the capture command instructs all or the subset of the one or more additional metering devices on the network to record their respective power system electrical parameters associated with the timing data of the electrical parameters that are defined by the trigger parameters.

11. The device according to claim 1:
further including a power supply, the power supply adapted to accept user input voltage, and to configure the input voltage to a system voltage for use by the metering assembly.

12. The device according to claim 11:
further including a backplane assembly adapted to pass at least one of system voltage and communication signals.

13. The device according to claim 12:
wherein the system voltage is transmitted from the power supply, across the backplane, and to the metering assembly.

14. A power quality measurement, control and management device for use in an electric power system and adapted to be coupled to a network, the device comprising:
an electric power system metering assembly including data memory and trigger parameters, the metering assembly adapted to capture, time stamp, and record in the data memory power system electrical parameters imposed on one or more industrial automation devices, each device representing a node in the electric power system;
a processor assembly including a communication interface, the communication interface adapted to communicate with one or more additional metering assemblies on a network, and the communication interface adapted to transmit a capture command to all or a subset of the one or more additional metering assemblies on the network;
each of the metering assembly and the processor assembly coupled to a backplane assembly, the backplane assembly adapted to pass communications between the metering assembly and the processor assembly; and
wherein when the metering assembly captures one or more power system electrical parameters that are defined by the trigger parameters, the metering assembly takes a snapshot of the recorded power system electrical parameters and stores the snapshot of the recorded power system electrical parameters in the data memory.

15. The device according to claim 14:
further including a power supply coupled to the backplane assembly, the power supply adapted to accept user input voltage, and to configure the input voltage to a system voltage for use by the processor assembly and the metering assembly.

16. The device according to claim 14:
wherein the recorded power system electrical parameters are only temporarily stored in the data memory.

17. The device according to claim 14:
wherein the snapshot of the recorded power system electrical parameters is stored in the data memory separate from the recorded power system electrical parameters.

18. The device according to claim 14:
wherein the backplane is adapted to provide electrical isolation between the processor assembly and the metering assembly and the power supply.

19. The device according to claim 14:
wherein when the metering assembly captures one or more power system electrical parameters that are defined by the trigger parameters, the communication interface transmits the capture command onto the network to instruct all or the subset of the one or more additional metering devices on the network to take a snapshot of the one or more additional metering device's recorded power system electrical parameters and to store the one or more additional metering device's snapshot of the recorded power system electrical parameters in the one or more additional metering device's data memory.

20. The device according to claim 19:
wherein the capture command includes timing data of the electrical parameters that are defined by the trigger parameters.

21. The device according to claim 20:
wherein the capture command instructs all or the subset of the one or more additional metering devices on the network to record their respective power system electrical parameters associated with the timing data of the electrical parameters that are defined by the trigger parameters.

22. A method of capturing power system electrical parameters with a plurality of networked electric power system metering assemblies, the power system electrical parameters imposed on one or more industrial automation devices, each device representing a node in the electric power system, the method comprising:
capturing, time stamping, and recording the power system electrical parameters imposed on the one or more industrial automation devices by at least one of the plurality of networked electric power system metering assemblies;
comparing the power system electrical parameters to trigger parameters; and
when the power system electrical parameters fall within the trigger parameters, instructing all or a subset of the plurality of networked electric power system metering assemblies on the network to take a snapshot of the respective metering device's recorded power system electrical parameters.

23. The method according to claim 22:
wherein instructing further includes instructing all or a subset of the plurality of networked electric power system metering assemblies on the network to take a snapshot of the respective metering device's recorded power system electrical parameters associated with timing data of the electrical parameters that fall within the trigger parameters.

24. The method according to claim 22 further including:
time-synchronizing a plurality of the snapshots of the respective metering device's recorded power system electrical parameters.

25. The method according to claim 24 further including:
presenting the time-synchronized snapshots to a user for analysis.
